(19) United States
(12) Patent Application Publication
(10) Pub. No.: US 2012/0246819 A1
(43) Pub. Date: Oct. 4, 2012

(54) POOL EDGE SEALING MEMBER AND POOL COVER ASSEMBLY AND METHOD EMPLOYING SAME

(76) Inventors: Corey HYATT, Wantagh, NY (US); Grace HYATT, Wantagh, NY (US)

(21) Appl. No.: 13/433,704

(22) Filed: Mar. 29, 2012

Related U.S. Application Data
(60) Provisional application No. 61/516,038, filed on Mar. 29, 2011.

(51) Int. Cl. E04H 4/00; B23P 11/00

(52) U.S. Cl. 4/503; 29/428

(57) ABSTRACT

Pool edge sealing members releasably attachable to an outer peripheral edge of a pool cover which has been secured to a surface surrounding a pool, to prevent debris from entering the pool. An assembly for covering a pool, to prevent debris from entering the pool, having a pool cover that is adapted to be removably secured over the pool and configured and dimensioned to completely cover the pool, a plurality of tie-downs attachable to the pool cover and corresponding anchors for removably securing the pool cover over the pool, and at least one pool edge sealing member. A method for covering a pool includes the steps of applying a predetermined length of at least one pool edge sealing member to the outer peripheral edge of a pool cover, to seal a gap formed between the pool cover and the surface surrounding the pool, to prevent debris from entering the pool.

### CROSS-REFERENCE TO RELATED APPLICATION

This application claims benefit from U.S. Provisional Application No. 61/516,038, filed Mar. 29, 2011, the contents of which are hereby incorporated by reference.

### BACKGROUND OF THE INVENTION

1. Field of the Invention

The invention relates to a pool edge sealing member releasably attachable to an outer peripheral edge of a pool cover which has been secured over a pool, to prevent debris from entering the pool. The invention also relates to an assembly, which includes a pool cover, means for securing the pool cover over a pool, and a pool edge sealing member attachable to the outer peripheral edge of the pool cover, to prevent debris from entering the pool. In addition, the invention relates to a method for covering a pool using the assembly, to prevent debris from entering the pool.

2. Brief Description of the Prior Art

Homeowners, or other individuals who own and/or maintain a pool, typically cover such pools with a tarp or swimming pool cover in the off season or at night, for safety considerations and to prevent debris or excess rain from entering the pool. In order for a pool cover to be properly secured over a pool, and to accomplish its intended safety functions, and to remain effectively in place for extended periods of time, the pool cover must be stretched tightly across the pool and anchored along its outer peripheral edge to the surface which surrounds the pool. Conventionally, to achieve a tensile, taut covering, a plurality of tie-downs, attachable to the outer peripheral edge of the pool cover are utilized. Preferably, the tie-down assemblies utilize a spring-loaded attachment mechanism, and/or a flat resilient strap, each having means for releasable attachment to corresponding anchor bolts secured to the surface surrounding the pool.

It is a known problem in the field that the resultant taut covering still leaves a gap, typically measuring approximately ⅜ to ½ inch between the outer peripheral edges of the pool cover and the surface surrounding the pool. The gap presents numerous problems for a pool owner. For example, the gap allows debris, e.g., leaves, grass clippings, mice and other contaminants, to infiltrate the pool, causing the water to turn murky and depositing a layer of decomposing material on the bottom of the pool.

When the pool is re-opened, typically at the start of a new season, extensive and extended cleaning preparations, such as vacuuming, flushing, and the introduction of chemicals are required to fully clean the pool prior to safe use thereof. The cleaning process is not only time consuming, but can be detrimental to the pool owner and the condition of the pool, because of the harmful nature of chemicals needed to remove the stains caused by the decomposing material.

### SUMMARY OF THE INVENTION

It is therefore an object of the present invention to provide a novel pool edge sealing member.

It is a further object to provide a pool edge sealing member releasably attachable to an outer peripheral edge of a pool cover.

It is another object to provide a pool edge sealing member releasably attachable to an outer peripheral edge of a pool cover which has been secured to a surface surrounding a pool, to prevent debris from entering the pool, thereby eliminating the need for extensive cleaning prior to re-use of the pool.

It is yet another object to provide a one-piece tubular pool edge sealing member which is inexpensive and easy to manufacture and install.

It is a further object to provide a simple assembly and method for covering a pool, to prevent debris from entering the pool.

Certain of the foregoing and related objects are readily attained according to the present invention by the provision of a pool edge sealing member releasably attachable to an outer peripheral edge of a pool cover which has been secured to a surface surrounding a pool, to prevent debris from entering the pool, comprising an elongated, resilient tubular member having a first end and an opposite second end; and a longitudinal slit formed in said tubular member which extends from said first end to said second end of said tubular member; wherein said slit of said tubular member is configured and dimensioned to releasably receive an outer peripheral edge of the pool cover, so that at least a portion of said tubular member seals a gap formed between the pool cover and the surface surrounding the pool, to prevent debris from entering the pool.

Preferably, said tubular member has a generally cylindrical shape. Most desirably, said longitudinal slit is a generally U-shaped channel. Advantageously, said tubular member is composed of a resilient material selected from the group consisting of rubber, plastic, rubber foam and plastic foam.

Certain of the foregoing and related objects are readily attained according to the present invention by the provision of an assembly for covering a pool, to prevent debris from entering the pool, comprising, a pool cover that is adapted to be removably secured over the pool and configured and dimensioned to completely cover the pool, said pool cover having an outer peripheral edge; and at least one pool edge sealing member comprising an elongated, resilient tubular member having a first end and an opposite second end and disposed along at least a portion of said outer peripheral edge of said pool cover, so that at least a portion of said tubular member seals a gap formed between said pool cover and a surface surrounding the pool, to prevent debris from entering the pool.

Optionally, said at least one pool edge sealing member is permanently affixed to said outer peripheral edge of said pool cover. In another embodiment, said at least one pool edge sealing member is releasably secured to said outer peripheral edge of said pool cover. Desirably, a longitudinal slit is formed in said tubular member which extends from said first end to said second end of said tubular member, wherein said slit of said tubular member is configured and dimensioned to releasably receive said outer peripheral edge of said pool cover.

Preferably, said tubular member has a generally cylindrical shape. Most desirably, said longitudinal slit is a generally U-shaped channel. Advantageously, said tubular member is composed of a resilient material selected from the group consisting of rubber, plastic, rubber foam and plastic foam. The assembly preferably includes a plurality of said pool edge sealing members.

Preferably, the assembly further comprises means for removably securing said pool cover over the pool, wherein said means attach said pool cover to a surface surrounding the pool. Most desirably, said means for removably securing said pool cover to the surface surrounding the pool comprise a plurality of spring-loaded tie-downs attachable to said pool cover, said tie-downs attachable to corresponding anchors secured to the surface surrounding the pool. Desirably, said means for removably securing said pool cover to the surface surrounding the pool are located at spaced-apart intervals along said outer peripheral edge of said pool cover. In a particular embodiment, said plurality of pool edge sealing members are located between said means for removably securing said pool cover to the surface surrounding the pool.

Certain of the foregoing and related objects are readily attained according to the present invention by the provision of a method for covering a pool, to prevent debris from entering the pool, the steps, comprising, providing an assembly for covering a pool, comprising a pool cover that is adapted to be removably secured over the pool and configured and dimensioned to completely cover the pool, said pool cover having an outer peripheral edge; and at least one pool edge sealing member comprising an elongated, resilient tubular member having a first end and an opposite second end and disposed along at least a portion of said outer peripheral edge of said pool cover, so that at least a portion of said tubular member seals a gap formed between said pool cover and a surface surrounding the pool, to prevent debris from entering the pool; and attaching a pre-determined length of said at least one pool edge sealing member to said outer peripheral edge of said pool cover, so that at least a portion of said tubular member seals a gap formed between said pool cover and the surface surrounding the pool, to prevent debris from entering the pool. Desirably, the method wherein said tubular member has a longitudinal slit formed therein which extends from said first end to said second end of said tubular member, wherein said slit of said tubular member is configured and dimensioned to releasably receive said outer peripheral edge of said pool cover; and wherein in said attaching step said pre-determined length of said at least one pool edge sealing member is releasably attached to said outer peripheral edge of said pool cover, so that said edge of said pool cover is releasably received within said slit of said tubular member.

Preferably, the method further comprising the steps of providing a plurality of pool edge sealing members; and applying said plurality of said pool edge sealing members to said outer peripheral edge of said pool cover, so that said edge of said pool cover is received within said slit of said tubular member to seal a gap formed between said pool cover and the surface surrounding the pool, to prevent debris from entering the pool. Desirably, the method further comprising means for removably securing said pool cover over the pool, wherein said means attach said pool cover to a surface surrounding the pool, wherein said means for removably securing said pool cover to the surface surrounding the pool are located at spaced-apart intervals along said outer peripheral edge of said pool cover; and said plurality of pool edge sealing members are applied to said outer peripheral edge of said pool cover between said means for removable securing said pool cover to the surface surrounding the pool.

### BRIEF DESCRIPTION OF THE DRAWINGS

FIG. 1 is a fragmentally-illustrated top perspective view, of a pool cover secured over a pool and anchored to the surface surrounding the pool, according to the prior art;

FIG. 2 is a side sectional view of a pool cover pool according to the prior art taken along line 2-2 of FIG. 1, showing a gap between the outer peripheral edge of the pool cover and the surface surrounding the pool, with debris entering into the pool through the gap;

FIG. 3 is a fragmentally-illustrated top perspective view, of a pool cover secured over a pool and anchored to the surface surrounding the pool according to the present invention, with a plurality of pool edge sealing members, one of which is shown prior to receipt on the pool cover edge; and

FIG. 4 is a side sectional view taken along line 4-4 of FIG. 3, showing a pool edge sealing member sealing the gap between the outer peripheral edge of the pool cover and the surface surrounding the pool, blocking debris from entering into the pool.

### DETAILED DESCRIPTION OF THE PREFERRED EMBODIMENTS

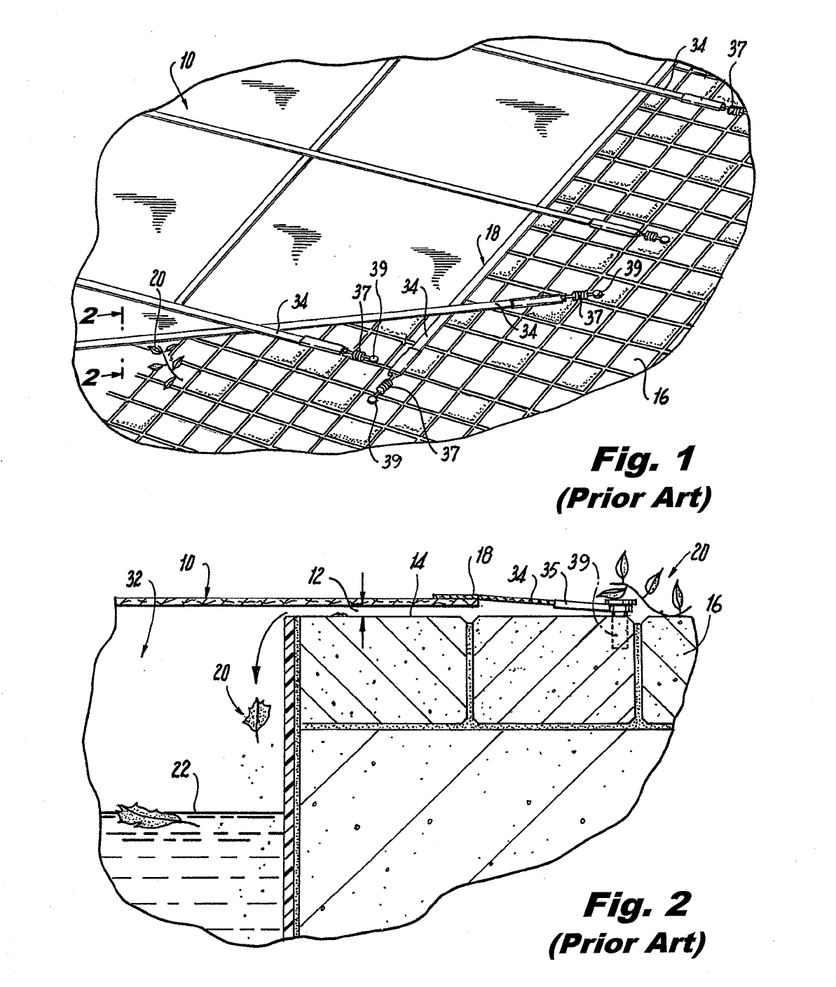

Referring to FIGS. 1-2, therein illustrated is a pool covering assembly according to the prior art, comprising a pool cover, generally designated by the numeral 10, secured over a pool 32 and anchored to the surrounding surface 16 of pool 32 via means for removably securing said pool cover over the pool, e.g., tie-downs 34. Preferably, tie-downs 34 are resilient, e.g., utilizing spring-loaded or elastic anchoring assemblies, as seen in U.S. Pat. No. 5,800,089 to Donaton, U.S. Pat. No. 5,014,369 to Daus, and U.S. Pat. No. 4,916,763 to Christensen, which are all hereby incorporated by reference. Tie-downs 34, are located at spaced-apart intervals along the outer peripheral edge 18 of pool cover 10, and are attachable, via anchoring assemblies 37 (FIG. 1) and/or 35 (FIG. 2), to corresponding anchors 39 secured to the surface 16 surrounding pool 32. Anchoring assembly 37 (FIG. 1) comprises a spring-loaded attachment mechanism having a looped end for releasable securement to anchor 39. Anchoring assembly 35 (FIG. 2) comprises a generally flat, elastic strap having a loop or aperture for securement to anchor 39. As is typical in most cases, even in the off season, the pool 32 remains filled with water 22, with debris 20 located strewn around the surrounding surface 16.

As seen in FIG. 2, when cover 10 is secured over pool 32, a gap 12 is left between the pool cover 10 and the upper face 14 of surrounding surface 16. As it can be appreciated, gap 12, between the pool cover 10 and the upper face 14, spans the entire perimeter of pool 32. Debris 20 located around the surrounding surface 16, and aided by the wind, is typically swept through gap 12 and into the water 22 of pool 32. As it can be appreciated, over time, debris 20 builds up on the bottom of pool 32, and necessitates extensive and extended cleaning preparations, such as vacuuming, flushing, and the introduction of chemicals to fully clean the pool 32 prior to safe use thereof.

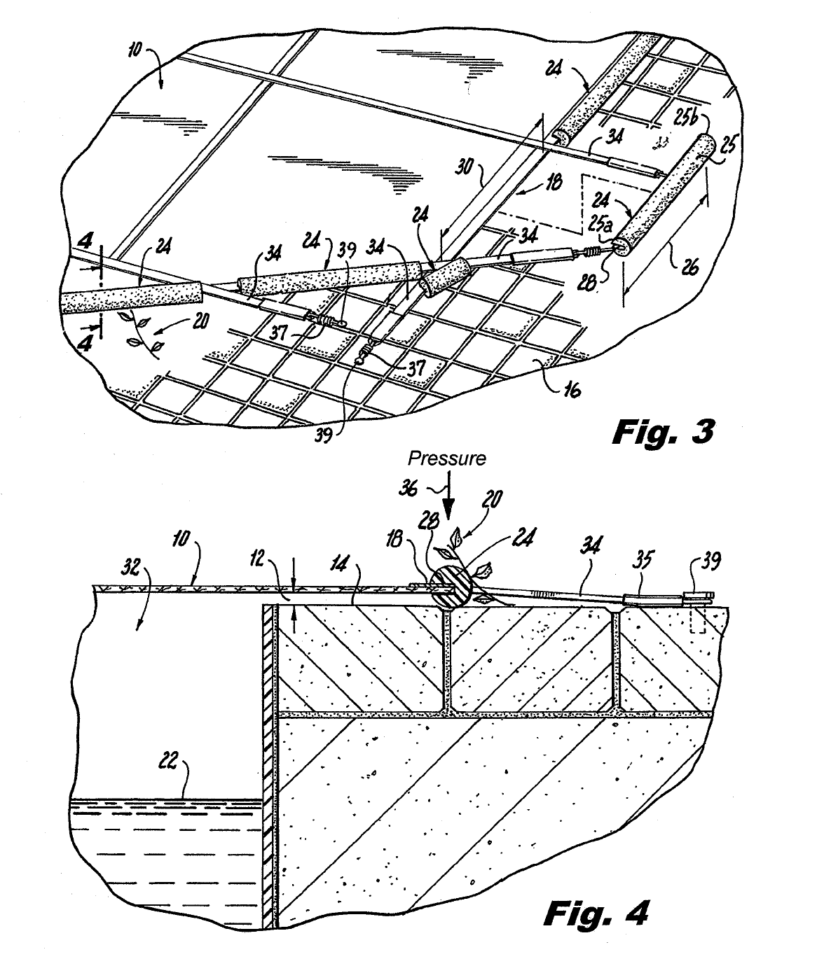

Referring to FIGS. 3-4, therein illustrated is pool covering assembly embodying the present invention comparable to that shown in FIGS. 1-2; however, as depicted, the assembly includes a plurality of pool edge sealing members, generally designated by reference numeral 24, which are releasably attachable to the outer peripheral edge 18 of pool cover 10.

As best seen in FIG. 3, pool edge sealing member 24 comprises an elongated, resilient tubular body member 25 with a first end 25a and an opposite second end 25b. Tubular body member 25 preferably has a longitudinal slit 28, which runs completely from first end 25a to second end 25b. Longitudinal slit 28 is configured and dimensioned to create a snug fit when the outer peripheral edge 18 of pool cover 10 is received therein. As it can be appreciated, longitudinal slit 28 can be a slit or cut extending partially through tubular body member 25. It may also take the form of a generally U-shaped channel formed in the tubular body member 25. Commercially available, cylindrical tubing used for pipe coverings of the type having a centrally-disposed, generally circular inner bore or channel and an elongated slit or opening extending through the tubing from the circular bore or channel to an outer face of the tubular body member 25 can also be utilized. In addition, other suitable configurations for slit 28 can be utilized as long as it permits a receipt therein for the outer peripheral edge 18 of pool cover 10.

As shown in FIG. 4, longitudinal slit 28 of pool edge sealing member 24 receives the outer peripheral edge 18 of pool cover 10 in a snug-fit manner, thus releasably attaching pool edge sealing member 24 to pool cover 10. In this attached position, the underside portion of pool edge sealing member 24 contacts the upper face 14 of surrounding surface 16, and seals gap 12 between pool cover 10 and surrounding surface 16. Means for removably securing pool cover 10 over the pool 32, e.g., tie-downs 34, with spring-loaded anchoring assembly 37 or elastic anchoring assembly 35, generates a downward force (arrow 36), contributing to a tighter seal between pool edge sealing member 24 and upper face 14, preventing any debris 20 from passing into pool 32 by closing off gap 12.

As depicted in FIGS. 1-4, the spaced-apart tie-downs 34 which anchor pool cover 10 to the surrounding surface 16 extend in a generally perpendicular manner from peripheral edge 18, via spring-loaded anchoring assembly 37 (FIG. 1) and/or elastic strap anchoring assembly 35 (FIG. 2) to corresponding anchors 39 secured to the surface 16, defining breaks, or sections 30 therebetween along peripheral edge 18. However, other suitable means to tie down and secure the pool cover 10 to the surface 16 surrounding the pool 32 can be utilized. As shown in FIG. 3, to account for sections 30 along peripheral edge 18, a plurality of pool edge sealing members 24, of a predetermined length 26 to correspond to the length of sections 30 are disposed between the tie-downs 34, and are releasably attached to the peripheral edge 18 of pool cover 10 for the entire perimeter of pool 32, thus sealing gap 12 and preventing any debris 20 from passing through gap 12 and into pool 32.

As shown in FIG. 3, during installation, each sealing member 24 is cut to size, or otherwise provided with a certain predetermined size, such that its length 26 corresponds to the length of a section 30 of peripheral edge 18 between two spaced-apart tie-downs 34. Longitudinal slit 28 of pool edge sealing member 24 is then inserted over section 30 of peripheral edge 18 between tie-downs 34, until peripheral edge 18 is snugly received within slit 28. As shown in FIG. 4, when in place, and the resilient tie-down 34, via spring-loaded anchoring assembly 37 or elastic strap anchoring assembly 35, is fixed to the anchor 39, the underside portion of pool edge sealing member 24 contacts the upper face 14 of surrounding surface 16, and seals gap 12 between pool cover 10 and surrounding surface 16. As shown, tie-downs 34 generate downward pressure (arrow 36), contributing to a tighter seal between pool edge sealing member 24 and upper face 14, preventing any debris 20 from passing through gap 12 and into pool 32.

The pool edge sealing member is preferably composed of a resilient plastic foam material, although other suitable materials can be used, such as rubber, plastic, foam rubber, or foam plastic, including the material utilized in conventional, commercially available heat insulation products. The pool edge sealing member can be of any length, and preferably has a width or diameter such that it can seal a gap of approximately ½ to ⅜ inches formed between a pool cover and the surrounding surface of the pool. The pool edge sealing member preferably is cylindrically-shaped, which contributes to minimal wind resistance, although other suitable shapes, such as rectangular or triangular are possible. The longitudinal channel of the pool edge sealing member may optionally be provided with means for attachment to the peripheral edge of the pool cover, such as an adhesive, snap-like buttons, VELCRO, or any other suitable means of attachment, if desired.

Although the pool edge sealing member and pool cover assembly and method employing the same are primarily directed to be retro-fitted to an existing pool covering system, it is also possible to combine the pool edge sealing member with the pool cover when manufactured. Therefore, optionally, a tarp or pool cover with a built-in peripheral compressible tubular sealing edge is possible. Particularly, the pool edge sealing member could be permanently attached to the outer peripheral edge of the pool cover via an adhesive, or other suitable securement means. In addition, it is also possible for the pool edge sealing member to be formed integrally with the outer peripheral edge of the pool cover. Alternatively, the pool edge sealing member could be received within a sleeve formed along the outer peripheral edge of the pool cover.

While particular embodiments of the invention have been described, it is not intended that the invention be limited thereto, as it is intended that the invention be as broad in scope as the prior art will allow and that the specification be read likewise. It will therefore be appreciated by those skilled in the art that other modifications could be made thereto without departing from the spirit and scope of the invention.

What is claimed is:

1. A pool edge sealing member releasably attachable to an outer peripheral edge of a pool cover which has been secured to a surface surrounding a pool, to prevent debris from entering the pool, comprising:
an elongated, resilient tubular member having a first end and an opposite second end; and
a longitudinal slit formed in said tubular member which extends from said first end to said second end of said tubular member;
wherein said slit of said tubular member is configured and dimensioned to releasably receive an outer peripheral edge of the pool cover, so that at least a portion of said tubular member seals a gap formed between the pool cover and the surface surrounding the pool, to prevent debris from entering the pool.

2. The pool edge sealing member of claim 1, wherein:
said tubular member has a generally cylindrical shape.

3. The pool edge sealing member of claim 1, wherein:
said longitudinal slit is a generally U-shaped channel.

4. The pool edge sealing member of claim 1, wherein:
said tubular member is composed of a resilient material selected from the group consisting of rubber, plastic, rubber foam and plastic foam.

5. An assembly for covering a pool, to prevent debris from entering the pool, comprising:
a pool cover that is adapted to be removably secured over the pool and configured and dimensioned to completely cover the pool, said pool cover having an outer peripheral edge; and
at least one pool edge sealing member comprising an elongated, resilient tubular member having a first end and an opposite second end and disposed along at least a portion of said outer peripheral edge of said pool cover, so that at least a portion of said tubular member seals a gap formed between said pool cover and a surface surrounding the pool, to prevent debris from entering the pool.

6. The assembly according to claim 5, wherein:
said at least one pool edge sealing member is permanently affixed to said outer peripheral edge of said pool cover.

7. The assembly according to claim 5, wherein:
said at least one pool edge sealing member is releasably secured to said outer peripheral edge of said pool cover.

8. The assembly according to claim 7, wherein:
a longitudinal slit is formed in said tubular member which extends from said first end to said second end of said tubular member, wherein said slit of said tubular member is configured and dimensioned to releasably receive said outer peripheral edge of said pool cover.

9. The assembly according to claim 5, wherein:
said tubular member has a generally cylindrical shape.

10. The assembly according to claim 8, wherein:
said longitudinal slit is a generally U-shaped channel.

11. The assembly according to claim 5, wherein:
said tubular member is composed of a resilient material selected from the group consisting of rubber, plastic, rubber foam and plastic foam.

12. The assembly according to claim 5, further comprising:
a plurality of said pool edge sealing members.

13. The assembly according to claim 5, further comprising:
means for removably securing said pool cover over the pool, wherein said means attach said pool cover to a surface surrounding the pool.

14. The assembly according to claim 13, wherein:
said means for removably securing said pool cover to the surface surrounding the pool comprise a plurality of spring-loaded tie-downs attachable to said pool cover, said tie-downs attachable to corresponding anchors secured to the surface surrounding the pool.

15. The assembly according to claim 13, wherein:
said means for removably securing said pool cover to the surface surrounding the pool are located at spaced-apart intervals along said outer peripheral edge of said pool cover.

16. The assembly according to claim 15, wherein:
said plurality of pool edge sealing members are located between said means for removably securing said pool cover to the surface surrounding the pool.

17. A method for covering a pool, to prevent debris from entering the pool, the steps, comprising:
providing an assembly for covering a pool, comprising a pool cover that is adapted to be removably secured over the pool and configured and dimensioned to completely cover the pool, said pool cover having an outer peripheral edge; and at least one pool edge sealing member comprising an elongated, resilient tubular member having a first end and an opposite second end and disposed along at least a portion of said outer peripheral edge of said pool cover, so that at least a portion of said tubular member seals a gap formed between said pool cover and a surface surrounding the pool, to prevent debris from entering the pool; and
attaching a pre-determined length of said at least one pool edge sealing member to said outer peripheral edge of said pool cover, so that at least a portion of said tubular member seals a gap formed between said pool cover and the surface surrounding the pool, to prevent debris from entering the pool.

18. The method according to claim 17, wherein:
said tubular member has a longitudinal slit formed therein which extends from said first end to said second end of said tubular member, wherein said slit of said tubular member is configured and dimensioned to releasably receive said outer peripheral edge of said pool cover; and
wherein in said attaching step said pre-determined length of said at least one pool edge sealing member is releasably attached to said outer peripheral edge of said pool cover, so that said edge of said pool cover is releasably received within said slit of said tubular member.

19. The method according to claim 18, further comprising the steps of:
providing a plurality of pool edge sealing members; and
applying said plurality of said pool edge sealing members to said outer peripheral edge of said pool cover, so that said edge of said pool cover is received within said slit of said tubular member to seal a gap formed between said pool cover and the surface surrounding the pool, to prevent debris from entering the pool.

20. The method according to claim 19, further comprising:
means for removably securing said pool cover over the pool, wherein said means attach said pool cover to a surface surrounding the pool, wherein said means for removably securing said pool cover to the surface surrounding the pool are located at spaced-apart intervals along said outer peripheral edge of said pool cover; and
said plurality of pool edge sealing members are applied to said outer peripheral edge of said pool cover between said means for removable securing said pool cover to the surface surrounding the pool.
